(19) United States
(12) Patent Application Publication
(10) Pub. No.: US 2004/0246407 A1
(43) Pub. Date: Dec. 9, 2004

(54) Liquid crystal display apparatus, mirror apparatus, and electric device having liquid crystal display apparatus

(75) Inventors: Masashi Tanaka, Kyoto (JP); Yukito Toriumi, Kyoto (JP)

Correspondence Address: Douglas P Mueller, Merchant & Gould, 3200 IDS Center, 80 South 8th Street, Minneapolis, MN, 55402-2215, US

(73) Assignee: ROHM CO., LTD., Kyoto (JP)

(21) Appl. No.: 10/492,502

(22) PCT Filed: Oct. 11, 2002
(86) PCT No.: PCT/JP02/10630

(30) Foreign Application Priority Data
Oct. 12, 2001 (JP) 2001-350822
Oct. 18, 2001 (JP) 2001-358505
May 10, 2002 (JP) 2002-173410

(51) Int. Cl. G02F 1/1335

(52) U.S. Cl. 349/96

(57) ABSTRACT

The present invention relates to a liquid crystal display (X1), to an electric equipment provided with this, and to a mirror device. The liquid crystal display (X1), and the mirror device as well, includes a liquid crystal panel (2) where liquid crystal (23) is held between first and second transparent substrates (21, 22), and a plurality of display areas for displaying target images are provided. The display also includes an absorption polarizer (26) which transmits light vibrating in a first direction and absorbs light vibrating in a direction crossing the first direction, and the polarizer is disposed on the side of the first transparent substrate side with respect to the liquid crystal panel. A reflection polarizer (27), which transmits light vibrating in a second direction and reflects light vibrating in a direction crossing the second direction, is disposed on the side of the second transparent substrate with respect to the liquid crystal panel (2). The reflection polarizer (27) is held to the liquid crystal panel (2) via an adhesive layer (29) which has a uniform refractive index. For the mirror device, it is arranged that the reflected light quantity is adjustable in accordance with the voltage applied state to the liquid crystal.

### TECHNICAL FIELD

The present invention relates to a liquid crystal display or mirror device which uses a reflection polarizer and liquid crystal, and to an electric equipment provided with the liquid crystal display.

### BACKGROUND ART

Among liquid crystal displays, there are reflection types which display images using external light. FIG. 22 and FIG. 23 show examples of a reflection type liquid crystal display.

In the liquid crystal display Y1 shown in FIG. 22, absorption polarizers (polarizing plates) 90 and 91 are bonded to the front face and rear face of the liquid crystal panel 8 respectively.

The absorption polarizers 90 and 91 are arranged such that the respective polarization axes (transmission axes) intersect orthogonally. Therefore the absorption polarizer 90 selectively transmits only the light which vibrates in a predetermined direction, and the absorption polarizer 91 selectively transmits the light which vibrates in a direction that intersects orthogonally with the above mentioned predetermined direction. A reflecting plate 92 is contacted to the absorption polarizer 91.

The liquid crystal panel 8 is comprised of a liquid crystal layer 82 where liquid crystal is filled between the first and second transparent substrates 80 and 81. Liquid crystal is filled in a 90° twisted state. On the first and second transparent substrates 80 and 81, a plurality of first and second transparent electrodes 83 and 84 are installed on the facing planes 80a and 81a. The first and second transparent electrodes 83 and 84 are formed in strips, and the first transparent electrode 83 and the second transparent electrode 84 are disposed so as to intersect orthogonally with each other. By this, voltage can be individually applied to liquid crystal which exist in an area where the first and second transparent electrodes 83 and 84 overlap with each other.

Light which is transmitted through the absorption polarizer 90 and vibrates in a predetermined direction enters the liquid crystal panel 8. In the liquid crystal panel 8, the vibrating direction of the light which transmits a portion of the liquid crystals which became an unselected waveform voltage applied state (a state where voltage sufficient to change the array status of liquid crystal molecules is applied) is changed 90°, and the vibrating direction of light which transmits a portion of liquid crystal which became a selected waveform voltage applied state (state where voltage sufficient to not change the array status of liquid crystal molecules (including 0V) is applied) is not changed. The polarization axis of the absorption polarizer 91 intersects orthogonally with the polarization axis of the absorption polarizer 90, so only the light which transmitted through a portion which became an unselected waveform voltage applied state transmits through the absorption polarizer 91, and the light which transmitted through a portion which is in a selected waveform voltage applied state is absorbed by the absorption polarizer 91. The light which transmitted through the absorption polarizer 91 is reflected by the reflecting plate 92 without a polarizing direction thereof being changed, and is emitted from the absorption polarizer 90 via a route opposite the original route. In other words, the portion which became the selected waveform voltage applied state is displayed as dark, and the portion which became the unselected waveform voltage applied state is displayed as bright. When the reflecting plate 92 is made of aluminum film, for example, the bright display portion is displayed in a silver color.

The liquid crystal display Y1 has a shortcoming in that the device becomes thick since the absorption polarizer 91 and the reflecting plate 92 must be installed on the back face of the liquid crystal panel 8. Also when a bright display is performed, light is emitted after transmitted through the absorption polarizers 90 and 91 a total of four times, so the utilization efficiency of light is poor. Therefore when the light quantity of external light is insufficient, the bright display portion becomes less bright and contrast becomes poor.

The liquid crystal display Y2 shown in FIG. 23 has the same basic configuration as the above described liquid crystal device, but the configuration of the portion to reflect external light is different. In FIG. 23, the identical elements as the liquid crystal display Y1 are denoted with identical reference numerals.

In the liquid crystal display Y2, the reflection polarizer 94 is bonded to the back face of the second transparent substrate 81 with adhesive 93. The adhesive 93 is one where beads 93a for light scattering are dispersed. A light absorption layer 95, which is black for example, is coated on the back face 94a of the reflection polarizer 94. The reflection polarizer 94 is comprised of a double refraction dielectric multi-layer film, for example, which transmits light which vibrates in a predetermined direction and reflects light which vibrates in directions different from above. In the liquid crystal display Y2, the polarization axis of the absorption polarizer 90 and the polarization axis of the reflection polarizer 94 are set in parallel. Therefore the light which transmitted through the portion which became a selected waveform voltage applied state, is transmitted through the reflection polarizer 94, and is absorbed in the light absorption layer 95, and a dark display is performed for this portion. The light which transmitted through the portion which became an unselected waveform voltage applied state, on the other hand, is reflected by the reflection polarizer 94, and is emitted from the liquid crystal display Y2, and bright display is performed for this portion.

The liquid crystal display Y2, where the reflection polarizer 94 having both a reflection function and polarization function is used, can be thinner for the thickness of the absorption polarizer, which need not be installed on the back face of the liquid crystal panel 8. If an absorption polarizer on the back face side is unnecessary, light absorption by the absorption polarizer does not occur. In addition, light can be scattered by beads 93a in the adhesive 93 which bonds with the reflection polarizer 94, so the display screen in general can be brighter. However, if the reflection polarizer 94 is used, the display screen has a glare. So if the liquid crystal display Y2 is integrated into electric equipment where the color in general is white, then a glaring liquid crystal display Y2 exists in white, which makes appearance poor. Such a liquid crystal device Y2 does not match not only with white but also with other colors. It is true that the brightness of the bright display portion is improved if light is scattered by the beads 93a. However, directivity becomes poor and the beads 93a become luminescent spots, which makes the display screen sparkle. As a result, the dark display portions become non-distinct, and the contrast drops.

### DISCLOSURE OF THE INVENTION

It is an object of the present invention to provide a liquid crystal display which is thin and has high contrast while maintaining the brightness of the display screen, and has an improved appearance when built in to an electric equipment. It is another object of the present invention to provide a mirror device having a configuration similar to the liquid crystal display, and to an electric equipment provided with the liquid crystal display.

According to a first aspect of the present invention, there is provided a liquid crystal display comprising: a liquid crystal panel which includes liquid crystal held between first and second transparent substrates and includes a plurality of display areas for displaying target images; an absorption polarizer which transmits light vibrating in a first direction and absorbs light vibrating in a direction crossing the first direction, the absorption polarizer being disposed on a side of the first transparent substrate with respect to said liquid crystal panel; and a reflection polarizer which transmits light vibrating in a second direction and reflects light vibrating in a direction crossing the second direction, the reflection polarizer being disposed at a side of the second transparent substrate with respect to the liquid crystal panel. The reflection polarizer is held to the liquid crystal panel via an adhesive layer which has a uniform refractive index.

The liquid crystal display of the present invention is constructed such that a selected waveform voltage applied state (state where a voltage sufficient to change the array of liquid crystal molecules is applied) and unselected waveform applied state (state where a voltage sufficient not to change the array of liquid crystal molecules (including 0V) is applied) for the display area can be independently selected. In this case, it may be preferable that the liquid crystal display is constructed such that bright display is performed by selecting the unselected waveform voltage applied state in each display area.

Preferably, a dielectric multi-layered film with a double refraction characteristic may be used for the reflection polarizer. In the dielectric multi-layered film, a plurality of dielectric layers which can reflect light with different wavelengths are layered. Therefore the reflection polarizer can reflect light in a wide wavelength range and can perform a brighter light display in a liquid crystal display.

The liquid crystal panel may be constructed, such that the images are viewed from the first transparent substrate side, for example. In this case, a light absorption layer for absorbing light which was transmitted through the reflection polarizer, or a color reflection layer for selectively reflecting light in a predetermined wavelength range, or a white reflection layer, may be disposed on the back face of the reflection polarizer.

If a white reflection layer is disposed on the back face of the liquid crystal panel, a light absorption layer for selectively absorbing light with a predetermined wavelength or a color filter layer for selectively transmitting light with a predetermined wavelength may be disposed between the liquid crystal panel and the white reflection layer. The color filter layer or the light absorption layer, which can select wavelength, may be disposed between the liquid crystal panel and the reflection polarizer. The reflection polarizer may be disposed at the front face side of the first transparent substrate. The reflection polarizer may be directly bonded to the liquid crystal panel.

An additional absorption polarizer for transmitting light vibrating in a third direction and absorbing light vibrating in a direction crossing the third direction may be disposed between the liquid crystal panel and the reflection polarizer. A phase difference film may be disposed between the liquid crystal panel and the additional absorption polarizer. The phase difference film may be disposed between the liquid crystal panel and the reflection polarizer, with the additional absorption polarizer omitted.

When the liquid crystal display is constructed such that the images are viewed from the first transparent substrate side, an absorption polarizer, which is anti-glare processed on the front face side, may be used.

The liquid crystal display of the present invention may further comprise an illumination device which emits light entering into the liquid crystal panel.

The illumination device may be disposed at the front face side of the liquid crystal panel, for example. It is preferable that the illumination device may further comprise a plurality of light sources which emit lights of different colors from each other and can drive lighting individually. It is preferable that the plurality of light sources may comprise a red light source for emitting red light, a green light source for emitting green light, and a blue light source for emitting blue light, and these light sources are constructed so that they can be lit individually or together in a combination.

In an illumination device using these light sources, a single color may be lit continuously, or light sources to be lit may be switched and lit sequentially. In the case of the former, the color of the background or display screen can be selected according to the desire of the user, for example. In the case of the later, the change of colors of the background and display image can be enjoyed.

According to a second aspect of the present invention, there is provided a liquid crystal display comprising: a liquid crystal panel which includes liquid crystal held between first and second transparent substrates and includes a plurality of display areas for target images to be viewed from a side of the first transparent substrate; an absorption polarizer which transmits light vibrating in a first direction and absorbs light vibrating in a direction crossing the first direction, and which is disposed on a front face side of the liquid crystal panel; a reflection polarizer which transmits light vibrating in a second direction and reflects light vibrating in a direction crossing the second direction, and which is disposed on a back face side of the liquid crystal panel; and a white reflection layer disposed on a back face side of the reflection polarizer.

For the display area in an unselected waveform voltage applied state, the light which transmitted through the reflection polarizer and which is reflected at the white reflection layer, for example, is emitted from the front face side of the liquid crystal panel, whereas for the display area in a selected waveform voltage applied state, the light which is reflected at the reflection polarizer, for example, is emitted from the front face side of the liquid crystal panel.

The reflection polarizer may be constructed as a dielectric multi-layer film which has a double refraction characteristic, for example.

In the liquid crystal display of the present invention, the light absorption layer for selectively absorbing light with a predetermined wavelength may be provided at the front face side of the reflection polarizer, or the color filter layer for selectively transmitting light with a predetermined wavelength may be provided at the front face side of the white reflection layer.

The reflection polarizer may be directly bonded to the liquid crystal panel, for example.

According to a third aspect of the present invention, there is provided a mirror device comprising: a liquid crystal panel including liquid crystal held between first and second transparent substrates; an absorption polarizer which transmits light vibrating in a first direction and absorbs light vibrating in a direction crossing the first direction, and which is disposed on a side of the first transparent substrate with respect to the liquid crystal panel; and a reflection polarizer which transmits light vibrating in a second direction and reflects, as a mirror, light vibrating in a direction crossing the second direction, and which is disposed on a side of the second transparent substrate with respect to the liquid crystal panel. The quantity of reflected light is adjustable in accordance with a voltage applied state with respect to the liquid crystal.

The reflection polarizer may be held to the liquid crystal panel, for example, via an adhesive layer where the refractive index is uniform. In this case, the reflection polarizer may be directly bonded to the liquid crystal panel.

For the reflection polarizer, preferably a dielectric multi-layer film which has a double refraction characteristic may be used.

Preferably, the mirror device may further comprise an illuminance sensor, and a control section for adjusting the voltage applied state to the liquid crystal in accordance with the illuminance detected by the illuminance sensor.

Here the adjustment of the “voltage applied state” may refer to the selection of the bright display or dark display in an individual display area of a plurality of display areas, or the adjustment of the applied voltage value to an individual display area.

According to a fourth aspect of the present invention, there is provided an electric equipment provided with a liquid crystal display, the electric equipment comprising: a liquid crystal panel including liquid crystal held between first and second transparent substrates and also including a plurality of display areas; an absorption polarizer which transmits light vibrating in a first direction and absorbs light vibrating in a direction crossing the first direction, and which is disposed on a side of the first transparent substrate side with respect to the liquid crystal panel; and a reflection polarizer which transmits light vibrating in a second direction and reflects light vibrating in a direction crossing the second direction, and which is disposed on a side of the second transparent substrate with respect to the liquid crystal panel. The reflection polarizer is held to the liquid crystal panel via an adhesive layer which has a uniform refractive index.

According to a fifth aspect of the present invention, there is provided an electric equipment provided with a liquid crystal display, the electric equipment comprising: a liquid crystal panel including liquid crystal held between first and second transparent substrates and also including a plurality of display areas for viewing target images from a side of the first transparent substrate; an absorption polarizer which transmits light vibrating in a first direction and absorbs light vibrating in a direction crossing the first direction, and which is disposed on a front face side of the liquid crystal panel; a reflection polarizer which transmits light vibrating in a second direction and reflects light vibrating in a direction crossing the second direction, and which is disposed on a back face side of the liquid crystal panel; and a white reflection layer disposed on a back face side of the reflection polarizer.

In the first to fifth aspects of the present invention, the meaning of “display area”, “front face”, “back face”, “first direction”, “second direction” and “third direction” are as described below. “Display area” refers to so called pixels and also to the display area corresponding to an individual segment electrode in the case of display performed in a predetermined plurality of areas by a plurality of segment electrodes, such as in the case of a calculator. “Front face” refers to a face at the side of viewing images displayed on a plurality of display area, and “back face” refers to a face at the opposite side thereof. “First direction”, “second direction” and “third direction” are directions which are individually defined for the absorption polarizer, reflection polarizer and an additional absorption polarizer respectively. Therefore, this includes not only the case when all of the first to third directions are different, but also to the case when all or two of the first to third directions point in the same direction.

### BRIEF DESCRIPTION OF THE DRAWINGS

FIG. 1 is a cross-sectional view depicting the liquid crystal display according to the first embodiment of the present invention;

FIG. 2 is a photograph when the image display status of a liquid crystal display (present invention 1) having a configuration similar to the liquid crystal display shown in FIG. 1 is taken by a digital camera;

FIG. 3 is a photograph when the image display status of a liquid crystal display (prior art 1) having a configuration similar to the conventional liquid crystal display shown in FIG. 22 is taken by a digital camera;

FIG. 4 is a photograph when a liquid crystal display (prior art 2) having a configuration similar to the conventional liquid crystal display shown in FIG. 23 is taken by a digital camera;

FIG. 5 is a cross-sectional view depicting the liquid crystal display according to the second embodiment of the present invention;

FIG. 6 is a cross-sectional view depicting the liquid crystal display according to the third embodiment of the present invention;

FIG. 7 is a photograph when the image display status of a liquid crystal display (present invention 2), where the polarization axes of the two polarizers intersect orthogonally in the liquid crystal display shown in FIG. 5, is taken by a digital camera;

FIG. 8A is a photograph when the image display status of a liquid crystal display (present invention 3) where an orange color reflection layer is created and the polarization axes of the two polarizers intersect orthogonally in the liquid crystal display shown in FIG. 6, is taken by a digital camera, and FIG. 8B is a photograph when the non-displayed status of a liquid crystal display (present invention 3) is taken by a digital camera;

FIG. 9A is a photograph when the image display status of a liquid crystal display (prior art 3) where an adhesive layer containing beads similar to that of the liquid crystal display (prior art 2) shown in FIG. 23 is used in the liquid crystal display (present invention 3) shown in FIG. 8A and FIG. 8B is taken by a digital camera, and FIG. 9B is a photograph when the non-displayed status of a liquid crystal display (prior art 3) is taken by a digital camera;

FIG. 10 is a cross-sectional view depicting the liquid crystal display according to the fourth embodiment of the present invention;

FIG. 11 is a cross-sectional view depicting the liquid crystal display according to the fifth embodiment of the present invention;

FIG. 12 is a cross-sectional view depicting the liquid crystal display according to the sixth embodiment of the present invention;

FIG. 13 is a cross-sectional view depicting the liquid crystal display according to the seventh embodiment of the present invention;

FIG. 14 is a cross-sectional view depicting the liquid crystal display according to the eighth embodiment of the present invention;

FIG. 15 is a cross-sectional view depicting the liquid crystal display according to the ninth embodiment of the present invention;

FIG. 16 is a cross-sectional view depicting the liquid crystal display according to the tenth embodiment of the present invention;

FIG. 17 is a cross-sectional view depicting the liquid crystal display according to the eleventh embodiment of the present invention;

FIG. 18 is a cross-sectional view depicting the liquid crystal display according to the twelfth embodiment of the present invention;

FIG. 19 is a cross-sectional view depicting the liquid crystal display according to the thirteenth embodiment of the present invention;

FIG. 20A is a front view depicting a rice cooker where the liquid crystal display is built-in, and FIG. 20B is a front view depicting a refrigerator where the liquid crystal display is built-in;

FIG. 21 is a cross-sectional view depicting an example of the mirror device according to the present invention, where a partial block diagram is used;

FIG. 22 is a cross-sectional view depicting an example of a conventional reflection type liquid crystal display; and

FIG. 23 is a cross-sectional view depicting another example of a conventional reflection type liquid crystal display.

### BEST MODE FOR CARRYING OUT THE INVENTION

The best mode for carrying out the invention will now be described with reference to the accompanying drawings.

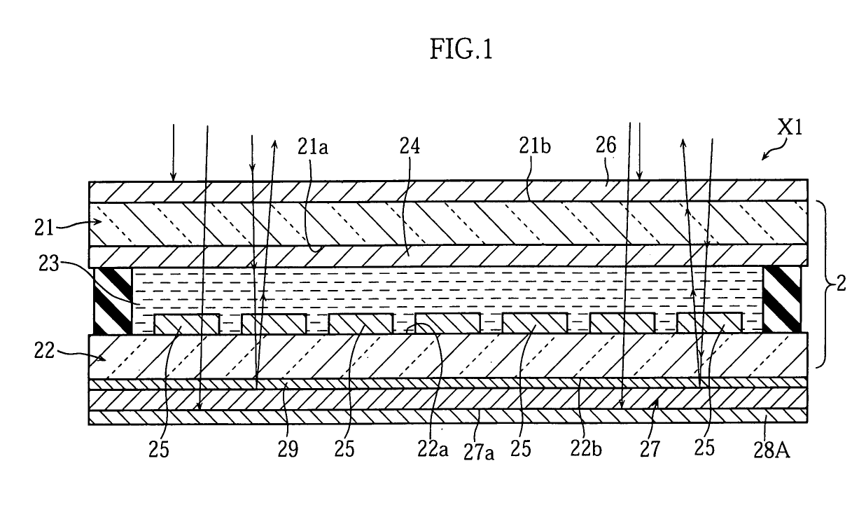

FIG. 1 shows a cross-sectional view depicting the liquid crystal display X1 according to the first embodiment of the present invention. The liquid crystal display X1 is constructed as a reflection type, and comprises the liquid crystal panel 2. In the liquid crystal panel 2, the liquid crystal layer 23 is created by filling liquid crystal between the first and second transparent substrates 21 and 22. The first and second transparent substrates 21 and 22 are formed from glass or acrylic resin, for example.

On the first and second transparent substrates 21 and 22, a plurality of first and second transparent electrodes 24 and 25 are disposed on the planes 21a and 22a thereof which face each other. Although not clearly shown in the figure, each first transparent electrode 24 is formed in a strip which extend in the left and right directions in FIG. 1. The plurality of first transparent electrodes 24 are arranged in the width direction of the first transparent electrode 24 (a direction intersecting orthogonally with the page face in FIG. 1). Each one of the second transparent electrodes 25 is also formed in a strip which extends in a direction intersecting orthogonally with the page face in FIG. 1. The plurality of second transparent electrodes 25 are also lined up in the width direction (left and right direction in FIG. 1) of the second transparent electrode 25, where each one of the second transparent electrodes 25 is formed so as to intersect with the first transparent electrode 24 orthogonally. The first and second transparent electrodes 24 and 25 can be formed by forming an ITO film by deposition or sputtering, for example, then performing etching processing. In such an electrode configuration, the area where the first and second transparent electrodes 24 and 25 cross creates a pixel (display area), and a plurality of pixels are arranged in a matrix.

The first and second transparent electrodes 24 and 25 are covered by an alignment film (not illustrated). The alignment film at the first transparent electrode 24 side and the alignment film at the second transparent electrode side are arranged such that the alignment directions thereof intersect orthogonally with each other. Therefore the liquid crystal molecules aer twisted 90°, for example, in a non-applied state. The liquid crystal molecules are oriented virtually free of the twisted state and become perpendicular if a predetermined or higher voltage is applied via the first and second transparent electrodes 24 and 25. The twist angle of the liquid crystal molecules [symbol] 90 chiral agent to be added to the liquid crystal layer 23.

The absorption polarizer (polarizing plate) 26 is bonded to the non-facing plane 21b of the first transparent substrate 21. The absorption polarizer 26 transmits light vibrating in a predetermined direction, such as in the left and right directions in FIG. 1, and absorbs light vibrating in a direction crossing the predetermined direction. The absorption polarizer 26 can be created by spreading transparent resin where diachronic pigment, such as iodine, is added. For the absorption polarizer 26, use may be made of an absorption polarizer, where anti-glare processing is performed on the front face side. Anti-glare processing is processing for diffusing reflected light by creating bumps on the surface. By performing anti-glare processing on the front face of the absorption polarizer 26, glare and reflection can be decreased.

To the non-facing plane 22b of the second transparent substrate 22, on the other hand, the reflection polarizer 27 is bonded. The reflection polarizer 27 transmits light vibrating in a predetermined direction and reflects light vibrating in a direction crossing this predetermined direction. In the present embodiment, the absorption polarizer 26 and the reflection polarizer 27 are disposed such that the polarization axes (transmission axes) thereof are in parallel, so that lights vibrating in a same direction are transmitted. The reflection polarizer 27 is bonded to the second transparent substrate 22 via the adhesive layer 29. The adhesive layer 29 has a uniform refraction index, and is made of acrylic resin, for example.

The reflection polarizer 27 is constructed as a dielectric multi-layered film which has a double refraction characteristic, for example. The dielectric multi-layered film is created by layering a plurality of dielectric layers, each of which is comprised of two high polymer layers with a different modulus of photo-elasticity, such as PEN (2, 6-polyethylene naphthalate, and coPEN (70-naphthalate/30-terephthalate copolyester), and spreading the plurality of dielectric layers over five times the area, for example.

As for each pair of PEN and coPEN, these high polymer layers have a refractive index different from each other in the spreading direction, and have the same refractive index in the direction intersecting orthogonally with the spreading direction. In other words, spreading in one direction makes each pair have a double refraction characteristic. In each dielectric layer, it is possible to reflect light vibrating in the extending direction depending on the difference of the refractive index, and also can transmit light vibrating in the direction which intersects orthogonally with the spreading direction. The condition that reflection occurs in each dielectric layer is that the sum of the optical paths length of the two high polymer layers (optical path length in a single dielectric layer) is ½ the wavelength. Therefore if a plurality of dielectric layers, which have different optical path lengths (thickness), are layered, light vibrating in the spreading direction can be reflected in a wide wavelength range.

The optical absorption layer 28A is created on the back face 27a of the reflection polarizer 27. The optical absorption layer 28A can be created by attaching black film, or by coating a resin containing black pigment.

Reaching the absorption polarizer 26 of the liquid crystal display X1, only the light components vibrating in a predetermined direction transmit through the absorption polarizer 26 to become polarized light, and enter the liquid crystal panel 2. This light transmits through the first transparent substrate 21, the first transparent electrode 24 and the alignment film (not illustrated), and then enters the liquid crystal layer 23. If light enters the portion where the twisted state of liquid crystal molecules is cleared by applying voltage (selected waveform voltage applied portion), the light transmits through the alignment film (not illustrated), the second transparent electrode 25 and the second transparent substrate 22, without changing the vibrating direction, and enters the reflection polarizer 27. The reflection polarizer 27 is bonded to the second transparent substrate 22 via the adhesive layer 29 where the refractive index is uniform, so the light which is emitted from the second transparent substrate 22 and reaches the reflection polarizer 27 advances linearly without scattering. The absorption polarizer 26 and the reflection polarizer 27 have parallel polarization axes, so the light which transmitted through the selected waveform voltage applied portion, transmits through the reflection polarizer 27 and is then absorbed at the light absorption layer 28A. Therefore pixels corresponding to the selected waveform voltage applied portion are dark-displayed.

For the light which entered a portion where the twisted state of the liquid crystal is not cleared (unselected waveform voltage applied portion), the [symbol] thereof is changed 90 enters the reflection polarizer 27. The light which entered the reflection polarizer 27 is reflected on the surface thereof, and is emitted from the liquid crystal display X1 via a route opposite the previous route. Therefore the unselected waveform voltage applied portion is bright-displayed.

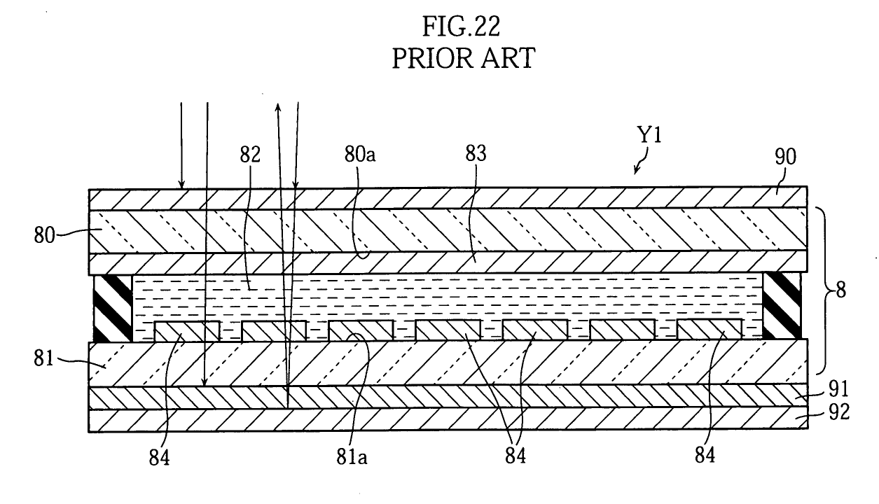

In the liquid crystal display X1, a reflection polarizer 27 which has both a polarization function and reflection function is used, so the thickness dimension of the device can be decreased since the absorption polarizer and the reflecting plate need not be created separately on the back face side of the liquid crystal panel 2. The reflection polarizer 27 is for selecting the transmission or reflection of light, so compared with a configuration where the absorption polarizer and the reflecting plate are created individually (see FIG. 22), the reflected light quantity can be increased since light is not absorbed by the absorption reflector. In particular, the dielectric multi-layered film can reflect the visible light in a wide wavelength range, so by using such a dielectric multi-layered film as the reflection polarizer 27, the reflected light quantity at the reflection polarizer can be increased. By increasing the reflected light quantity in this way, the display screen of the liquid crystal display X1 can be brighter.

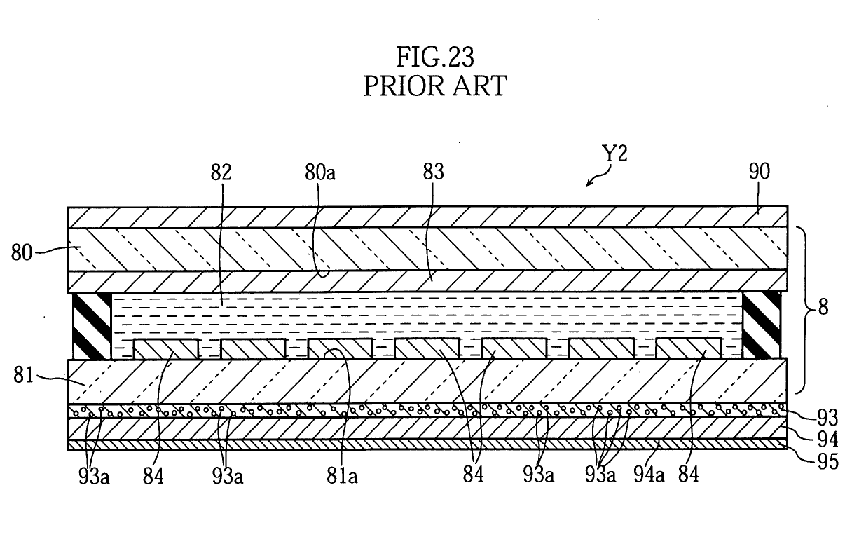

In the liquid crystal display X1, the liquid crystal panel 2 and the reflection polarizer 27 are bonded via the adhesive layer where the refractive index is uniform, as described above, so the light which transmits through them advances linearly without being scattered. Therefore in the liquid crystal display X1, the directivity of the reflected light is high and the reflected light quantity can be increased even more, compared with the configuration where the reflection polarizer is bonded with adhesive where beads are dispersed (see FIG. 23). Therefore in the liquid crystal display X1, the light display can be performed like a mirror, so the liquid crystal display can be used as a mirror by making the entire display screen a bright display. Here the liquid crystal display X1 is constructed such that bright display is performed by selecting the unselected waveform voltage applied state, therefore to perform bright display using the device as a mirror, effective voltage, which is lower than that of the dark display area, can be applied. This makes power consumption, when using the device as a mirror, low. In the liquid crystal display X1, while images are displayed in a part of the liquid crystal panel 2, the rest of the area may be used as a mirror.

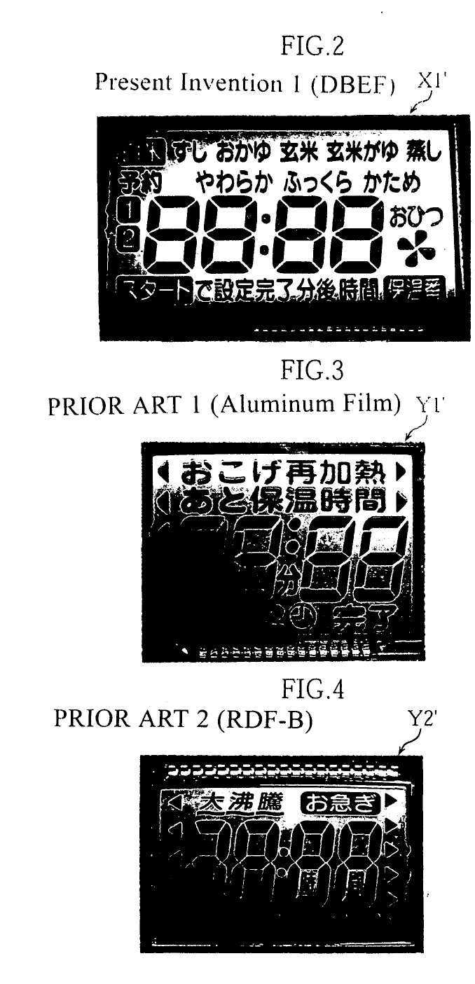

In the liquid crystal display X1, the emission light quantity to the viewing side is high and the display screen is bright, which can be seen in FIG. 2 to FIG. 4. FIG. 2 is a photograph of the image display state of the liquid crystal display X1′ which has a configuration similar to the liquid crystal display X1 shown in FIG. 1, FIG. 3 is a photograph of the image display status of the liquid crystal display Y1′ which has a configuration similar to the conventional liquid crystal display Y1 shown in FIG. 22, and FIG. 4 is a photograph of the image display status of the liquid crystal display Y2′ which has a configuration similar to the conventional liquid crystal display Y2 shown in FIG. 23, all taken by a digital camera (DSC-PS, manufactured by Sony) respectively. In the liquid crystal displays X1′,Y1′ and Y2′, the first transparent electrodes (24, 83) and the second transparent electrodes (25, 84) are created as segment electrodes corresponding to the display content. Each liquid crystal display X1′,Y1′ and Y2′ were photographed under the same conditions indoors.

In the liquid crystal displays X1′,Y1′ and Y2′, the configuration (material used, cell gap and thickness dimensions of each element) of the liquid crystal panels (2, 8) is the same, and the same absorption polarizer (26, 90) at the front face side of the liquid crystal panel (2, 8) is used. In the liquid crystal display X1′, DBEF (made by Sumitomo 3M) is glued on the back face of the liquid crystal panel (2) as the reflection polarizer (27), and black film (“X30”, made by Toray) is glued on the back face of the reflection polarizer (27) as the light absorption layer (28A). In the liquid crystal display Y1′, the absorption polarizer (91), the same one as glued at the front face side of the liquid crystal panel (8), is glued on the back face side, and then PET film with a 50 μm thick aluminum film deposited is glued to the polarizer, to provide the reflecting plate (92). In the liquid crystal display Y2′, RDF-B (made by Sumitomo 3M) is attached to the back face of the liquid crystal panel (8). To provide the RDF-B, one face of the reflection polarizer (94) is coated in black using vinyl resin to create the light absorption layer (95), and adhesive (93) containing beads (93a) is coated on the other face of the reflection polarizer (94).

As seen from FIG. 2 to FIG. 4, the display screen of the conventional liquid crystal display Y1′, where aluminum film is used as the reflecting plate (92), is the darkest, and the display screens of the liquid crystal display X1′, where DBEF is used, and of the liquid crystal display Y2′, where RDF-B is used, are brighter. As is known by a comparison of FIG. 2 and FIG. 4, the bright display part of the liquid crystal display X1′ is brighter with a mirror like reflection than that of the liquid crystal display Y2′. In other words, the liquid crystal display X1′ has a higher directivity of reflected light and more reflected light quantity.

Needless to say, the configuration of the liquid crystal display according to the present invention is not limited to the one described with reference to FIG. 1. When the display content is predetermined, for example, like the case of the liquid crystal display X1′ shown in FIG. 2, the first and second transparent electrodes may be created as a plurality of segment electrodes by patterning corresponding to the content, without creating these electrodes in strips, or one electrode of the first and second transparent electrodes may be created as one film, which extends over the entire surface of the transparent substrate. In the case of the configuration where at least one of the transparent electrodes is created as segment electrodes, voltage is not applied to the portion where the segment electrodes are not created, so this portion becomes bright with a mirror like reflection, just like a bright display. If the electrode uncreated area is bright like this, the reflected light thereof makes it difficult for off segments (segment electrodes in an unselected waveform voltage applied state) to be seen from the outside. As a result, a display state with good appearance can be implemented.

In the liquid crystal display X1, the light absorption layer 28A (see FIG. 1) may be omitted. In this case, a transparent display image is seen in the mirror like background.

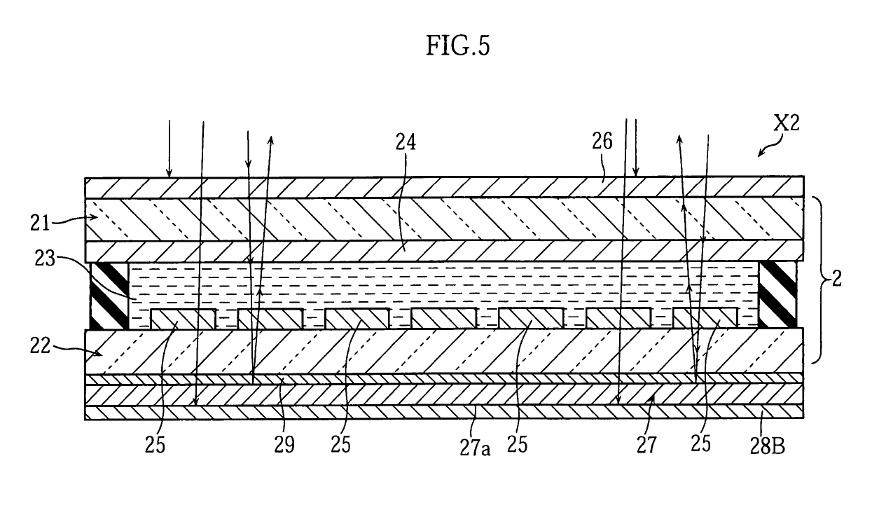

FIG. 5 shows a cross-sectional view depicting the liquid crystal display according to the second embodiment of the present invention. This liquid crystal display X2 has the configuration of the liquid crystal display X1 in FIG. 1, wherein the white reflection layer 28B is created rather than the light absorption layer 28A (see FIG. 1). In the liquid crystal display X2, the absorption polarizer 26 and the reflection polarizer 27 are disposed such that the polarization axis of the absorption polarizer 26 and the polarization axis of the reflection polarizer 27 intersect orthogonally with each other. In this configuration, the background of the liquid crystal display X2 is constructed by the reflected light from the white reflection layer 28B, and images are displayed by the reflected light from the reflection polarizer 27. As a result, the background of the liquid crystal display X2 becomes whitish, and the glare of the display screen can be suppressed. Therefore compared with the configuration where the reflection polarizer is bonded using adhesive in which beads are dispersed (see FIG. 23), the glare of the display screen is suppressed, so appearance improves even if the display is built in to an electric equipment where the general color is white. Such a liquid crystal display X2 can match not only when the general color of the electric equipment is white, but also with other colors.

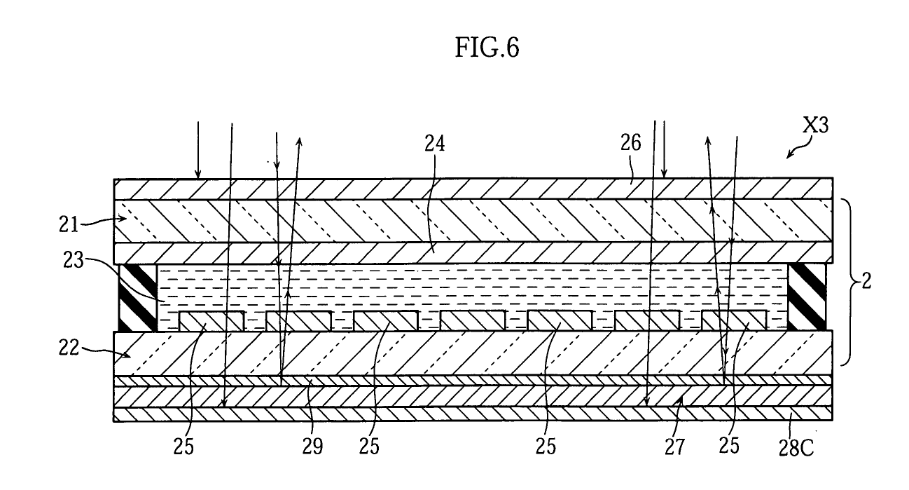

FIG. 6 shows a cross-sectional view depicting the liquid crystal display according to the third embodiment of the present invention. This liquid crystal display X3 has a configuration of the liquid crystal display X1 in FIG. 1, wherein the color reflection layer 28C is created rather than the light absorption layer 28A (see FIG. 1). In the liquid crystal display X3, the absorption polarizer 26 and the reflection polarizer 27 are disposed such that the polarization axes of the polarizers 26 and 27 are in parallel. In the case of this configuration, images are displayed by the reflected light at the color reflection layer 28C, so color images are displayed in a mirror like background. On the other hand, if each polarizer 26 and 27 are disposed such that the polarization axes of the polarizers 26 and 27 intersect orthogonally, then mirror like images are displayed in the color background. Therefore by using the color reflection layer 28C, background or display images are in color, and images with a good appearance can be displayed.

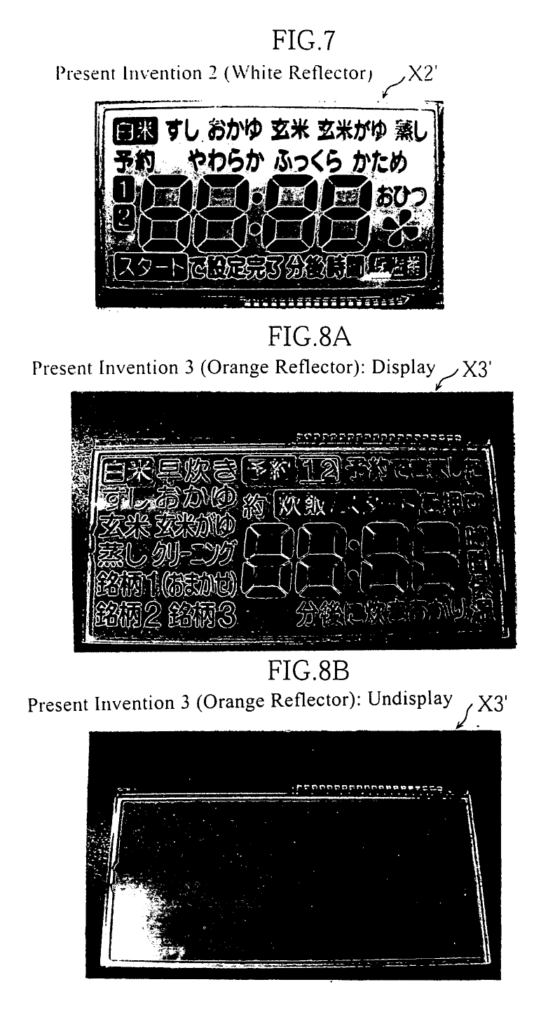

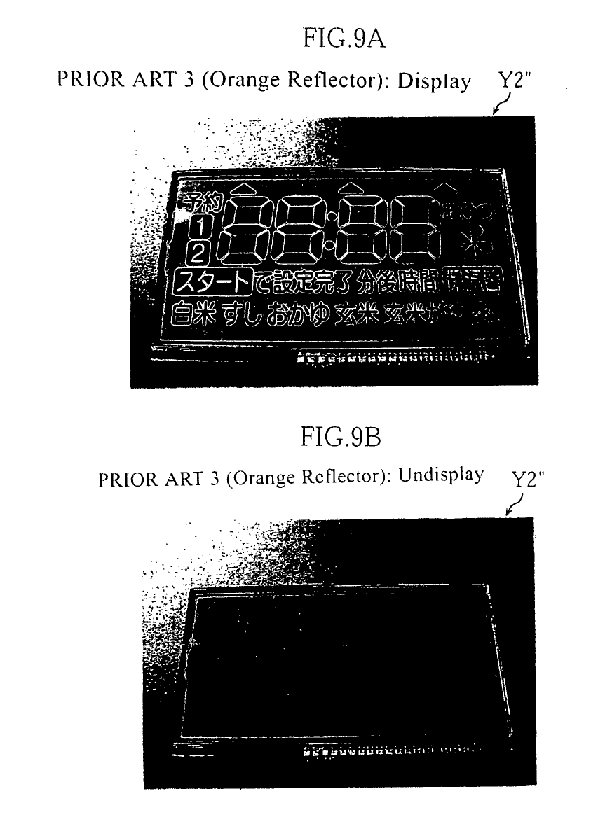

The technical advantages of the liquid crystal displays X2 and X3 shown in FIG. 5 and FIG. 6 can be seen from FIG. 7 to FIG. 9. FIG. 7 is a photograph of the image display state of the liquid crystal display X2′, which is a liquid crystal display with a configuration similar to the liquid crystal display X2 shown in FIG. 5, wherein the polarization axis of the absorption polarizer (26) and the polarization axis of the reflection polarizer (27) intersect orthogonally. FIG. 8A and FIG. 8B are photographs of the liquid crystal display X3′ (no beads in adhesive layer), which is a liquid crystal display with a configuration similar to the liquid crystal display X3 shown in FIG. 6, wherein an orange color reflection layer (28C) is disposed and the polarization axis of the absorption polarizer (26) and the polarization axis of the reflection polarizer (27) intersect orthogonally. FIG. 9 is a photograph of the liquid crystal display Y2″, which is a liquid crystal display X3′ (with beads in adhesive layer) shown in FIG. 8A and FIG. 8B, wherein an adhesive layer containing beads, just like the liquid crystal display Y2 shown in FIG. 23, is used. All the pictures are taken by a digital camera (“DSC-PS”, made by Sony) respectively. FIG. 8A and FIG. 9A show the image display status, and FIG. 8B and FIG. 9B show the image undisplayed state. In the liquid crystal displays X2′, X3′ and Y2″, the first transparent electrodes (24, 83) and the second transparent electrodes (25, 84) are created as segment electrodes corresponding to the display content, and these liquid crystal displays X2′, X3′ and Y2″ thereof were photographed under the same conditions indoors.

In the liquid crystal display X2′ shown in FIG. 7, a white film (“E60”, made by Toray) is used as the white reflection layer (29B). In the liquid crystal displays X3′ and Y2″ shown in FIG. 8A, FIG. 8B, FIG. 9A and FIG. 9B, a white film (“E60”, made by Toray), on which orange fluorescent paint is printed, is used as the color reflection layer (28C).

As is known by a comparison with FIG. 3, the liquid crystal display X2′ shown in FIG. 7 has a display screen brighter than the conventional liquid crystal display Y1′, where aluminum film is used as the reflecting plate (92), and a larger reflected light quantity is secured. As is known by a comparison of FIG. 7 with FIG. 4, in the liquid crystal display X2′, the general screen is more whitish and has less glare compared with the liquid crystal display Y2′, and glitter is also suppressed.

In the liquid crystal display X3′ shown in FIG. 8A and FIG. 8B (using an adhesive layer without beads (where refractive index in uniform)) on the other hand, the display screen is brighter in both image display state and undisplayed state compared with the liquid crystal display Y2″ shown in FIG. 9A and FIG. 9B (using color reflection layer (28C) rather than the light absorption layer (28A) ). As FIG. 8A and FIG. 8B show, the liquid crystal display X3′ using the color reflection layer (28C) has a good appearance, where the background is in color.

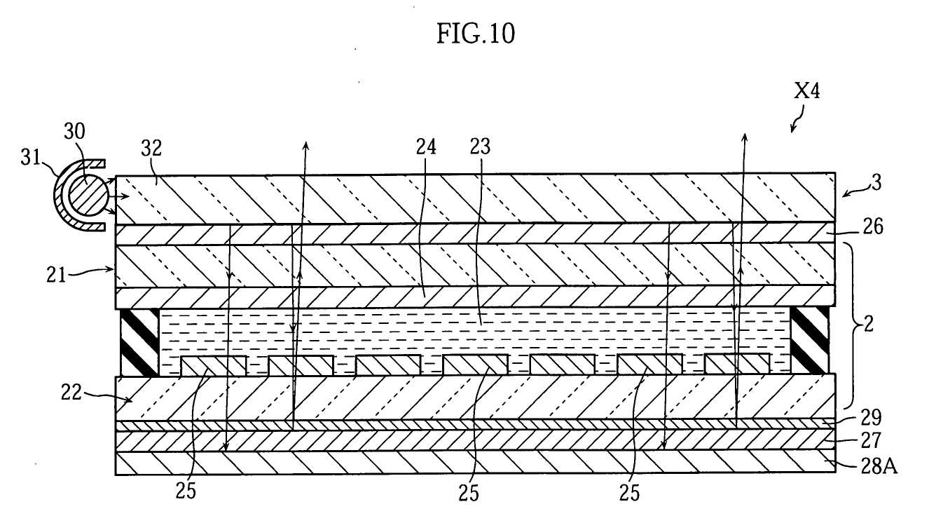

In the present invention, the liquid crystal display may be constructed as shown in FIG. 10 to FIG. 19. In FIG. 10 to FIG. 19, identical reference numerals are used to designate identical or equivalent portions or elements previously described, for which redundant descriptions are omitted.

FIG. 10 shows a cross-sectional view depicting the liquid crystal display X4 according to the fourth embodiment of the present invention. This liquid crystal display X4 is the liquid crystal display X1 shown in FIG. 1, wherein the illumination device 3 is disposed at the front face side of the liquid crystal panel 2. The illumination device 3 is comprised of a light source 30, reflecting plate 31, and light guiding plate 32. The light source 30 is constructed as a line light source, such as a cold cathode tube. For the light source 30, such a point light as LED may be used. The reflecting plate 31 is disposed so as to cover the light source 30. The portion of the light source 30 facing the light guiding plate 32 however is exposed. The inner face of the reflecting plate 31 is a surface where the light reflectance is high, so that the light emitted from the light source 30 is reflected and is entered to the light guiding plate 32. The light guiding plate 32 is for diffusing the light from the light source 30, and emitting the light on a plane to the liquid crystal panel 2. In the case of the liquid crystal display X4 using such an illumination device 3, light can be emitted on a plane from the front face of the liquid crystal panel 2, so light display can be performed like a mirror, even if the light quantity of external light cannot be sufficiently secured.

In the liquid crystal display X4 as well, design changes similar to the liquid crystal display X1 shown in FIG. 1 are possible, and for example, the light absorption layer 28A (see FIG. 1) may be omitted, or the white reflection layer 28B or color reflection layer 28C may be created rather than the light absorption layer 28A (see FIG. 5 and FIG. 6).

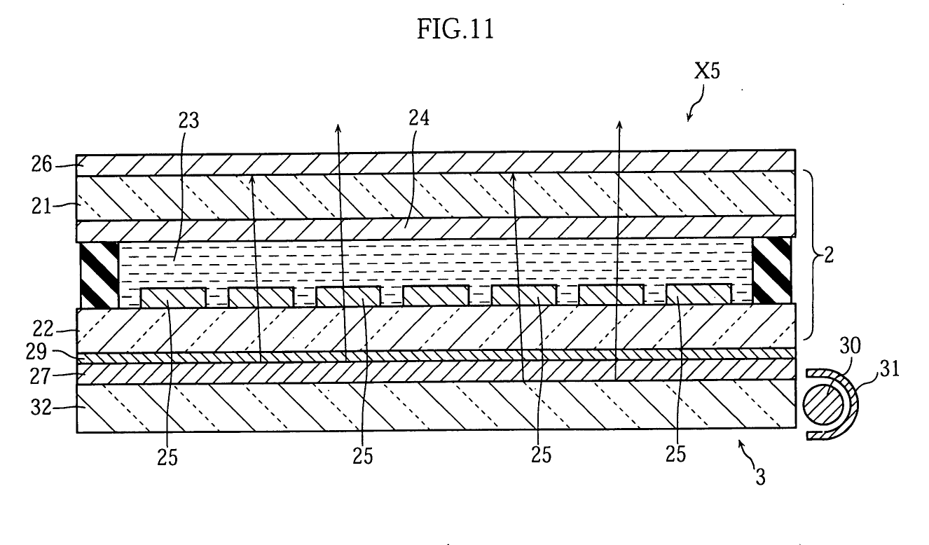

FIG. 11 shows a cross-sectional view depicting the liquid crystal display X5 according to the fifth embodiment of the present invention. This liquid crystal display X5 is constructed as a transmission type, where the illumination device 3 is disposed at the back face side of the liquid crystal panel 2. In this case, the light absorption layer 28A (see FIG. 1) is omitted. In the liquid crystal display X5, if the transmission axes of the reflection polarizer 27 and the absorption polarizer 26 are in parallel, then the selected waveform voltage applied portion is bright displayed, and the unselected waveform voltage applied portion is dark displayed. In other words, negative/positive are reversed with the liquid crystal display X1. If the transmission axes of the reflection polarizer 27 and the absorption polarizer 26 intersect orthogonally, the selected waveform voltage applied portion is dark displayed, and the unselected waveform voltage applied portion is bright displayed.

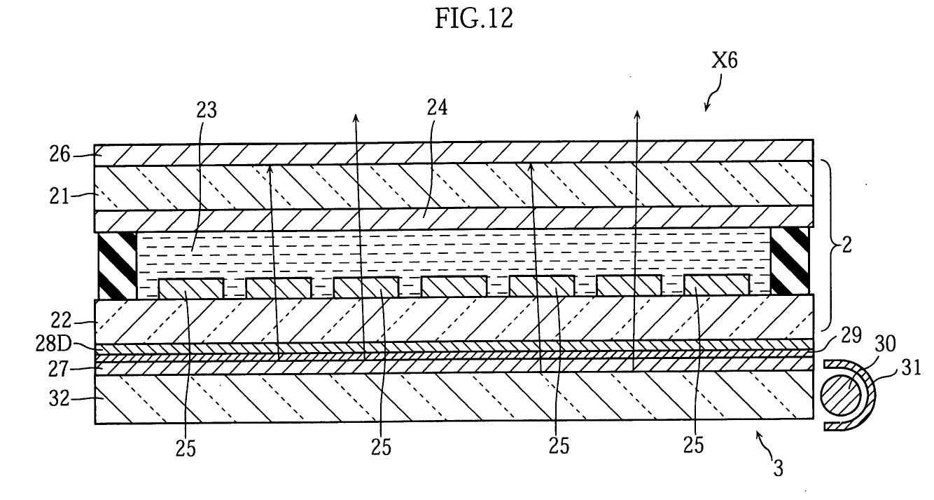

FIG. 12 shows a cross-sectional view depicting the liquid crystal display X6 according to the sixth embodiment of the present invention. This liquid crystal display X6 is the liquid crystal display X5 shown in FIG. 11, where the color filter layer 28D is provided between the liquid crystal panel 2 and the reflection polarizer 27. The reflection polarizer 27 is bonded to the color filter layer 28D via the adhesive layer 29. The adhesive layer 29 is constructed such that the refractive index is uniform, just like the case of the liquid crystal display X1. The color filter layer 28D is for selectively transmitting light with a predetermined wavelength.

In the liquid crystal display X6, image and background are viewed by the light transmitted through the color filter layer 28D, and an image display with a good appearance can be performed.

The liquid crystal display X6 can be built in to electric equipment with a good appearance by selecting the type (e.g. color) of the color filter layer 28D according to the color of the electric equipment to which the liquid crystal display X6 is built in. The color filter layer 28D may be provided by bonding a color filter or by forming color resin or ink into the layer.

In the liquid crystal display X6, the light absorption layer may be created by performing anti-reflection processing on the back face of the second transparent substrate 22, rather than the color filter layer 28D.

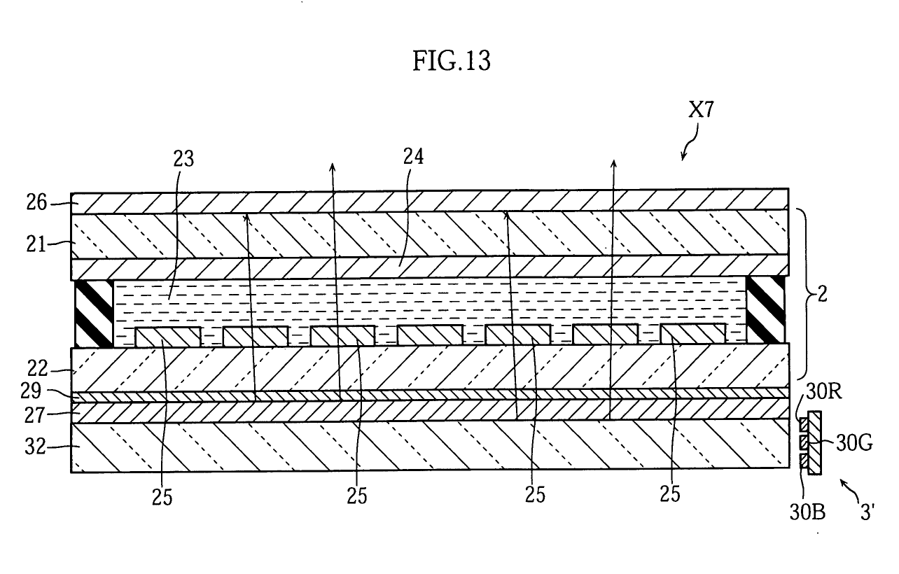

FIG. 13 shows a cross-sectional view depicting the liquid crystal display X7 according to the seventh embodiment of the present invention. This liquid crystal display X7 is the liquid crystal display X5 shown in FIG. 11, wherein three light sources, 30R, 30G and 30B are used for the illumination device 3′. The light source 30R is for emitting red light, the light source 30G is for emitting green light, and the light source 30B is for emitting blue light. For the light sources 30R, 30G and 30B, use may be made of while LEDs covered by color filters to produce red, green or blue light, or color LEDs designed to emit these colors of light by themselves. The light sources 30R, 30G and 30B can be independently driven by a non-illustrated driver IC, whereby one light alone or two or more light sources may light simultaneously. In other words, the illumination device 3′ is constructed such that red, green or blue light or a light where two or all of these colors are mixed, can be emitted.

If such an illumination device 3′ is used, the background or images of the liquid crystal display X7 are displayed in a color according to the color of the light emitted from the illumination device 3′, so an image display with good appearance is possible. The light to be emitted from the illumination device 3′ may be selected manually by the user, or may be automatically selected at the device side. The same color may be lit continuously, or the color may be changed at a predetermined time so that the change of the background and image colors can be enjoyed.

The illumination device 3′ may also be used for the liquid crystal display X4 shown in FIG. 10.

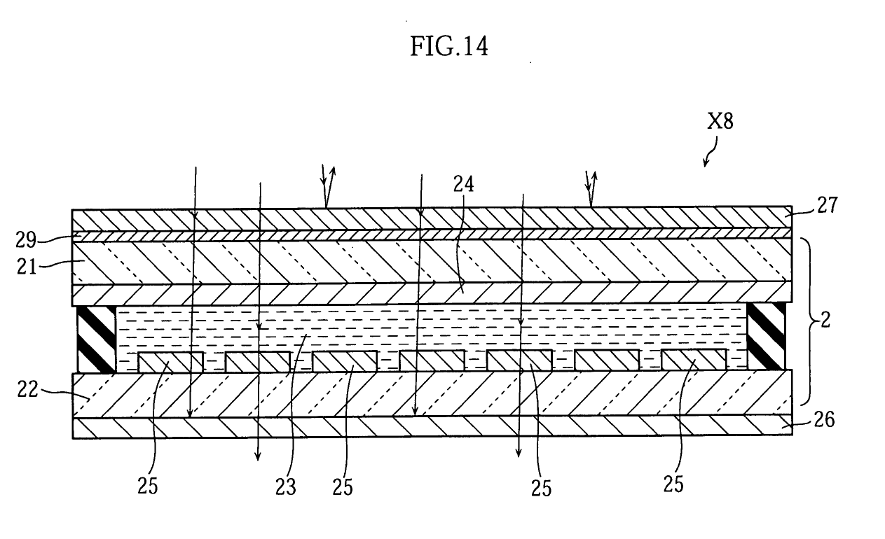

FIG. 14 shows a cross-sectional view of the liquid crystal display X8 according to the eighth embodiment of the present invention. In this liquid crystal display X8, the reflection polarizer 27 is disposed at the front face side of the liquid crystal panel 2, and the absorption polarizer 26 is disposed at the back face side of the liquid crystal panel 2. In other words, the top and bottom of the liquid crystal display X1 in FIG. 1 is reversed in this configuration. In the liquid crystal display X8, light components other than those vibrating in a predetermined direction are reflected by the reflection polarizer 27 to create the background. The incident light vibrating in the predetermined direction is absorbed, if the polarization axes of the reflection polarizer 27 and the absorption polarizer 26 intersect orthogonally, by the absorption polarizer 26 for a selected waveform voltage applied portion to provide dark display. For the unselected waveform voltage applied portion, the light transmits through the absorption polarizer 26, so that bright display is performed by reflection at the reflection polarizer 27. Needless to say, the polarizers 26 and 27 may be disposed such that the polarization axes of the reflection polarizer 27 and the absorption polarizer 26 become parallel. In this case, the negative and the positive are reversed.

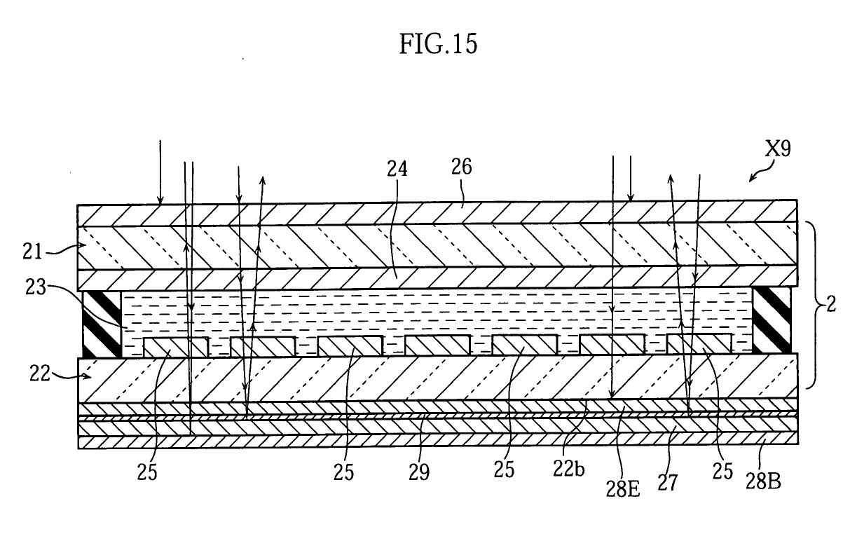

FIG. 15 shows a cross-sectional view depicting the liquid crystal display X9 according to the ninth embodiment of the present invention. The liquid crystal display X9 is the liquid crystal display X2 shown in FIG. 5 (comprising the white reflection layer 28B at the back face side of the liquid crystal panel 2), wherein the light absorption layer 28E is disposed between the liquid crystal panel 2 (second transparent substrate 22) and the reflection polarizer 27. The light absorption layer 28E is for selectively absorbing light in a predetermined wavelength range. The light absorption layer 28E can be created by performing anti-reflection processing on the non-facing plane 22b of the second transparent substrate 22, for example. The reflection polarizer 27 is bonded to the light absorption layer 28E via the adhesive layer 29. The adhesive layer 29 is constructed such that the refractive index is uniform, just like the case of the liquid crystal display X1.

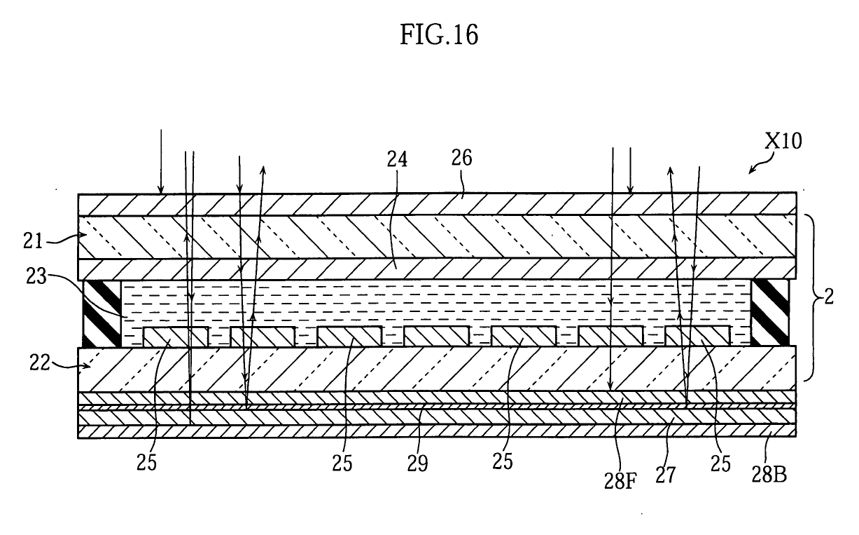

FIG. 16 is a cross-sectional view depicting the liquid crystal display X10 according to the tenth embodiment of the present invention. This liquid crystal display X10 is the liquid crystal display X9 shown in FIG. 15, wherein the color filter layer 28F is disposed rather than the light absorption layer 28E. The color filter layer 28F is for selectively transmitting light in a predetermined wavelength range.

In the liquid crystal displays X9 and X10 shown in FIG. 15 and FIG. 16, light components which propagate between the liquid crystal panel 2 and the reflection polarizer 27 can be selected depending on the wavelength by creating the light absorption layer 28E or the color filter layer 28F. As a result, the wavelength of the light components to be emitted from the liquid crystal displays X9 and X10 can be selected, therefore the reflected light quantity at the reflection polarizer 27 is decreased, and glare can be further suppressed.

The light absorption layer 28E or the color filter layer 28F may be created at the front face side of the liquid crystal panel 2 without compromising the technical advantage noted above. If the polarization axis of the absorption polarizer 26 and the polarization axis of the reflection polarizer 27 are in parallel, then the background is created by the reflected light at the reflection polarizer 27. In this case, the light absorption layer 28E or the color filter 28F can effectively suppress the glare of the background.

In the liquid crystal displays X9 and X10 shown in FIG. 15 and FIG. 16, the light absorption layer 28E or the color filter layer 28F may be disposed between the reflection polarizer 27 and the white reflection layer 28B. In this case, only the reflected light from the white reflection layer 28B is visible with the color according to the characteristics of the light absorption layer 28E or the color filter layer 28F.

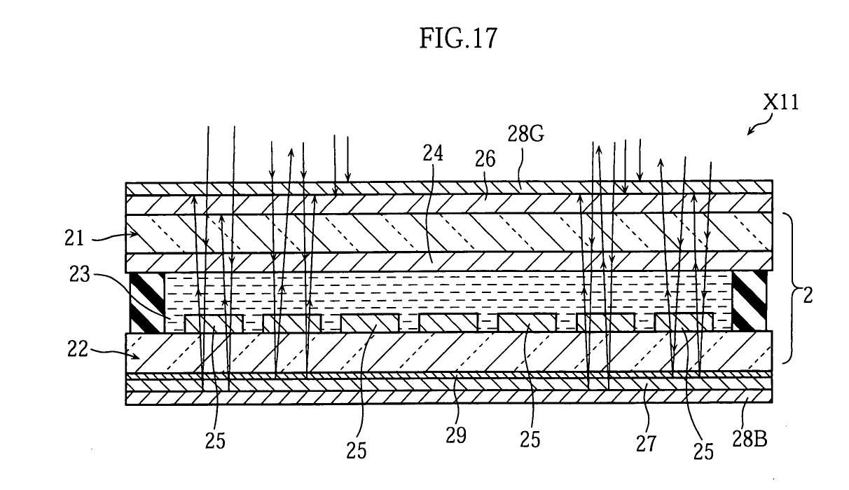

FIG. 17 shows a cross-sectional view of the liquid crystal display X11 according to the eleventh embodiment of the present invention. This liquid crystal display X11 is the liquid crystal display X2 shown in FIG. 5 (the white reflection layer 28B being provided at the back face side of the liquid crystal panel), wherein the color filter layer 28G is created on the front face of the absorption polarizer 26. The color filter layer 28G is for selectively transmitting the light in a predetermined wavelength range. Specifically, the light with a predetermined wavelength is selectively transmitted when the light enters the liquid crystal panel 2 from the outside (front face), or the light is emitted from the liquid crystal panel 2 to the outside (front face). As a result, light with the wavelength selected by the color filter layer 28G is emitted from the liquid crystal display X11, and the images and background are displayed with a color according to the selected wavelength. At this time, the light reflected at the reflection polarizer 27 is viewed with more glare than the light reflected at the white reflection layer 28B, so that these lights can be distinguished.

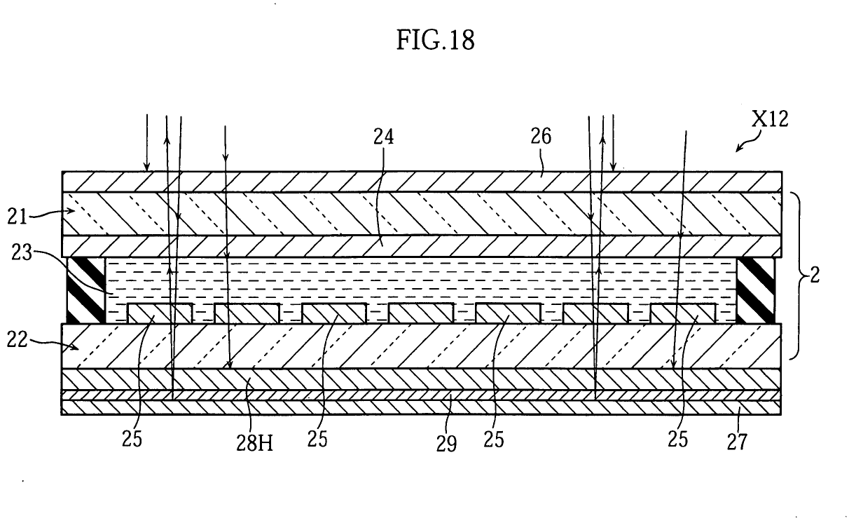

FIG. 18 shows a cross-sectional view of the liquid crystal display X12 according to the twelfth embodiment of the present invention. This liquid crystal display X12 is the liquid crystal display X1 shown in FIG. 1, wherein the light absorption layer 28A is omitted and the absorption polarizer 28H is disposed between the liquid crystal panel 2 and the reflection polarizer 27. This absorption polarizer 28H is disposed such that the polarization axis thereof intersects orthogonally with the polarization axis of the reflection polarizer 27. The reflection polarizer 27 is bonded to the absorption polarizer 28H via the adhesive layer 29. The adhesive layer 29 is constructed such that the refractive index is uniform, just like the case of the liquid crystal display X1.

In this liquid crystal display X12, the light transmitted through the liquid crystal panel transmits through the absorption polarizer 28H and is reflected at the reflection polarizer 27 or is absorbed at the absorption polarizer 28H. Therefore in the liquid crystal display X12, a black image can be displayed for the mirror like background, just like the case of the liquid crystal display X1 (see FIG. 1).

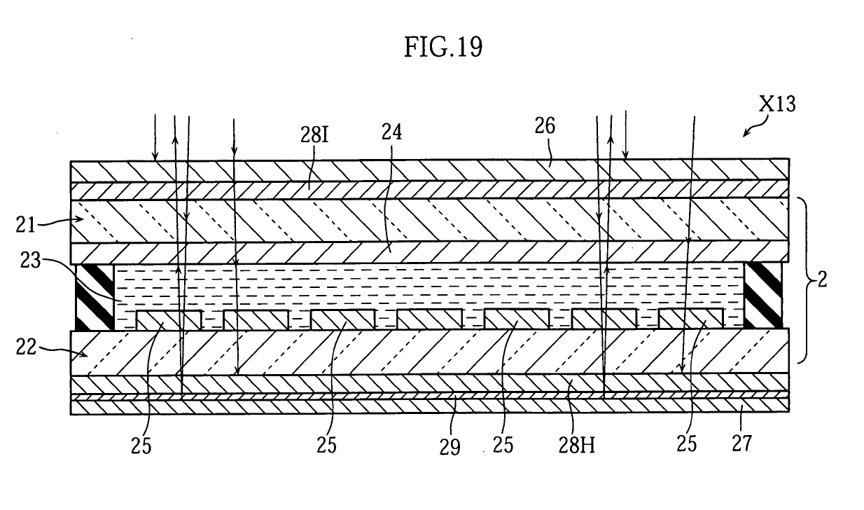

FIG. 19 shows a cross-sectional view depicting the liquid crystal display X13 according to the thirteenth embodiment of the present invention. This liquid crystal display X13 is the liquid crystal display X12 shown in FIG. 18, wherein the phase difference film 28I is disposed between the liquid crystal panel 2 (first transparent substrate 21) and the absorption polarizer 26.

In this configuration, the phase difference film 28I is used, so the color of the reflected light at the reflection polarizer 27 is decreased, and the contrast between dark display and light display can be enhanced. Therefore in the liquid crystal display X13, appropriate light and dark display becomes possible, even if an STN liquid crystal panel (liquid crystal molecules in an [symbol] 180 liquid crystal panel 2.

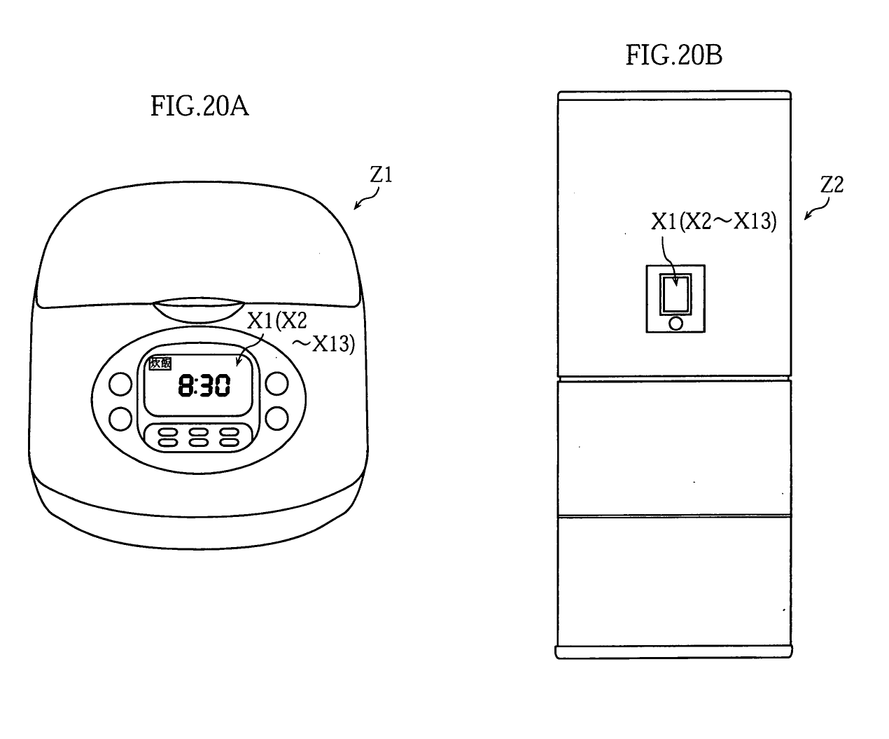

The above mentioned liquid crystal displays X1 to X13 can be built in to an electric equipment, for example, and used. FIG. 20A shows an example when one of the liquid crystal displays X1 to X13 is built in to a rice cooker Z1, and FIG. 20B shows an example when one of the liquid crystal displays X1 to X13 is built in to a refrigerator Z2. The rice cooker Z1 and the refrigerator Z2 are just examples, and the liquid crystal displays X1 to X13 may be built in to other home electric equipment, such as audio equipment and AV equipment.

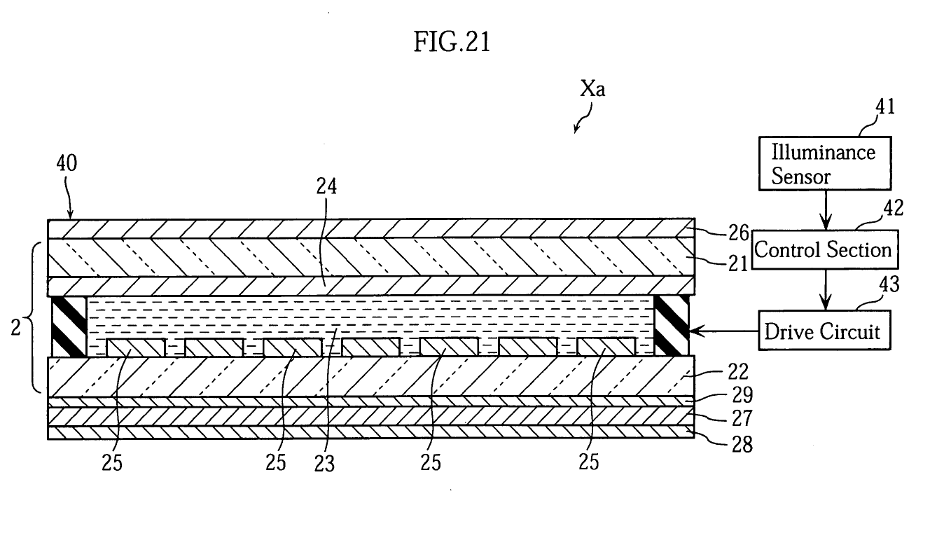

Now a mirror device according to the present invention will be described with reference to FIG. 21. The mirror device Xa comprises a liquid crystal panel device 40, an illuminance sensor 41, a control section 42 and a drive circuit 43.

The liquid crystal panel device 40 has an identical configuration as the liquid crystal display X1 which was described with reference to FIG. 1. Therefore in the liquid crystal panel display 40 in FIG. 21, identical elements as the liquid crystal display X1 are denoted with identical reference numerals. When voltage is not applied to the liquid crystal layer 23, the liquid crystal panel device 40 becomes a mirror, since external light is reflected at the reflection polarizer 27, and the reflected light quantity becomes highest. And the reflected light quantity can be adjusted by adjusting the voltage applied state to the liquid crystals. For example, selected pixels are set to a selected waveform voltage applied state, and a part of the pixels are used for dark display so as to decrease the reflected light quantity, or an applied voltage value is adjusted for the selected or for all pixels, thereby adjusting the reflected light quantity.

The illuminance sensor 41 is for detecting the brightness of the surroundings of the mirror device Xa, and is comprised of a photo-transistor, for example. This illuminance sensor 41 is disposed at a section appropriate for detecting the quantity of light which propagates toward the front face of the mirror device Xa.

The control section 42 is comprised of a CPU and a memory associated therewith, for example. The control section 42 selects the pixels to be brought into the selected waveform voltage applied state, based on the illuminance detected by the illuminance sensor 41, or instructs the drive circuit 43 to adjust the applied voltage value at each pixel. The drive circuit 43, on the other hand, adjusts the voltage applied state based on the instruction from the control section 42, thereby adjusting the reflected light quantity of the entire device.

In this mirror device Xa, the reflected light quantity can be decreased when surroundings are bright, and the reflected light quantity can be increased when the surroundings are dark. Therefore it is possible to avoid the state where the display is excessively bright because the surroundings are bright, or the state where the reflected light quantity is insufficient because the surroundings are too dark. In this manner, the reflection status matching the brightness of the surroundings can be selected so that the images reflected on the mirror device Xa can be appropriately confirmed. Also the reflected light quantity at the mirror device Xa is automatically adjusted by the control section 42 based on the brightness of the surroundings detected by the illuminance sensor 41, so the mirror device Xa is a device which can be easily used according to the brightness of the surroundings.

For the mirror device, at least one of the first and second transparent electrodes may be formed as one film which extends over the entire surface of the transparent substrate. With this configuration, compared with the configuration where a plurality of strip type electrodes are provided, there is one common electrode, and the number of electrodes, for which an applied voltage value is adjusted, is predominantly less, so the adjustment of the reflected light quantity is easier. According to the present invention, the mirror device may be constructed such that the reflected light quantity is adjusted, not automatically, but by manual operation.

1. A liquid crystal display comprising:
a liquid crystal panel which includes liquid crystal held between first and second transparent substrates and includes a plurality of display areas for displaying target images;
an absorption polarizer which transmits light vibrating in a first direction and absorbs light vibrating in a direction crossing the first direction, the absorption polarizer being disposed on a side of the first transparent substrate with respect to said liquid crystal panel; and
a reflection polarizer which transmits light vibrating in a second direction and reflects light vibrating in a direction crossing the second direction, the reflection polarizer being disposed at a side of the second transparent substrate with respect to the liquid crystal panel;
wherein the reflection polarizer is held to the liquid crystal panel via an adhesive layer which has a uniform refractive index.

2. The liquid crystal display according to claim 1, wherein the reflection polarizer is directly bonded to the liquid crystal panel.

3. The liquid crystal display according to claim 1, wherein a selected waveform voltage applied state and an unselected waveform applied state are individually selected for each of the display areas,
wherein in each of the display areas, bright display is performed by selecting the unselected waveform voltage applied state.

4. The liquid crystal display according to claim 1, wherein the reflection polarizer is constructed as a dielectric multi-layered film which has a double refraction characteristic.

5. The liquid crystal display according to claim 1, wherein an image is viewed from the side of the first transparent substrate, and
wherein the reflection polarizer includes a back face on which a light absorption layer for absorbing light transmitted through the reflection polarizer is provided.

6. The liquid crystal display according to claim 1, wherein an image is viewed from the side of the first transparent substrate, and
wherein the reflection polarizer includes a back face on which a color reflection layer for selectively reflecting light in a predetermined wavelength range is provided.

7. The liquid crystal display according to claim 1, wherein an image is viewed from the side of the first transparent substrate, and
wherein the reflection polarizer includes a back face on which a white reflection layer is provided.

8. The liquid crystal display according to claim 7, further comprising a light absorption layer disposed between the liquid crystal panel and the white reflection layer for selectively absorbing light of a predetermined wavelength.

9. The liquid crystal display according to claim 7, further comprising a color filter layer disposed between the liquid crystal panel and the white reflection layer for selectively transmitting light of a predetermined wavelength.

10. The liquid crystal display according to claim 1, further comprising an additional absorption polarizer disposed between the liquid crystal panel and the reflection polarizer for transmitting light vibrating in a third direction and absorbing light vibrating in a direction crossing the third direction.

11. The liquid crystal display according to claim 10, further comprising a phase difference film disposed between the liquid crystal panel and the additional absorption polarizer.

12. The liquid crystal display according to claim 1, further comprising a phase difference film disposed between the liquid crystal panel and the reflection polarizer.

13. The liquid crystal display according to claim 1, further comprising a color filter layer disposed between the liquid crystal panel and the reflection polarizer for selectively transmitting light of a predetermined wavelength.

14. The liquid crystal display according to claim 1, further comprising a light absorption layer disposed between the liquid crystal panel and the reflection polarizer for selectively absorbing light of a predetermined wavelength.

15. The liquid crystal display according to claim 1, wherein an image is viewed from the side of the first transparent substrate, and
wherein the absorption polarizer is subjected to anti-glare treatment on a front face side thereof.

16. The liquid crystal display according to claim 1, further comprising an illumination device which emits light entering the liquid crystal panel.

17. The liquid crystal display according to claim 16, wherein an image is viewed from the side of the first transparent substrate,
wherein the illumination device is disposed on a back face side of the reflection polarizer.

18. The liquid crystal display according to claim 16, wherein the illumination device comprises a plurality of light sources which emit lights of different colors and can drive lighting individually.

19. The liquid crystal display according to claim 18, wherein the plurality of light sources comprise a red light source for emitting red light, a green light source for emitting green light, and a blue light source for emitting blue light, and
wherein these light sources are designed to be lit alone or together in a combination.

20. A liquid crystal display comprising:
a liquid crystal panel which includes liquid crystal held between first and second transparent substrates and includes a plurality of display areas for target images to be viewed from a side of the first transparent substrate;
an absorption polarizer which transmits light vibrating in a first direction and absorbs light vibrating in a direction crossing the first direction, and which is disposed on a front face side of the liquid crystal panel;
a reflection polarizer which transmits light vibrating in a second direction and reflects light vibrating in a direction crossing the second direction, and which is disposed on a back face side of the liquid crystal panel; and
a white reflection layer disposed on a back face side of the reflection polarizer.

21. The liquid crystal display according to claim 20, wherein light transmitted through the reflection polarizer and reflected at the white reflection layer is emitted from the front face side of the liquid crystal panel for display areas held in an unselected waveform voltage applied state, and wherein light reflected at the reflection polarizer is emitted from the front face side of the liquid crystal panel for display areas held in a selected waveform voltage applied state.

22. The liquid crystal display according to claim 20, wherein the reflection polarizer is constructed as a dielectric multi-layer film which has a double refraction characteristic.

23. The liquid crystal display according to claim 20, further comprising a light absorption layer disposed between the liquid crystal panel and the reflection polarizer for selectively absorbing light of a predetermined wavelength.

24. The liquid crystal display according to claim 20, further comprising a color filter layer disposed between the liquid crystal panel and the reflection polarizer for selectively transmitting light of a predetermined wavelength.

25. The liquid crystal display according to claim 20, wherein the reflection polarizer is directly bonded to the second transparent substrate.

26. A mirror device comprising:
a liquid crystal panel including liquid crystal held between first and second transparent substrates;
an absorption polarizer which transmits light vibrating in a first direction and absorbs light vibrating in a direction crossing the first direction, and which is disposed on a side of the first transparent substrate with respect to the liquid crystal panel; and
a reflection polarizer which transmits light vibrating in a second direction and reflects, as a mirror, light vibrating in a direction crossing the second direction, and which is disposed on a side of the second transparent substrate with respect to the liquid crystal panel;
wherein reflected light quantity is adjustable in accordance with a voltage applied state with respect to the liquid crystal.

27. The mirror device according to claim 26, wherein the reflection polarizer is held to the liquid crystal panel via an adhesive layer having a uniform refractive index.

28. The mirror device according to claim 27, wherein the reflection polarizer is directly bonded to the liquid crystal panel.

29. The mirror device according to claim 26, wherein the reflection polarizer is constructed as a dielectric multi-layered film which has a double refraction characteristic.

30. The mirror device according to claim 26, further comprising: an illuminance sensor;
and a control section for adjusting the voltage applied state to the liquid crystal in accordance with illuminance detected by the illuminance sensor.

31. An electric equipment provided with a liquid crystal display, the electric equipment comprising:
a liquid crystal panel including liquid crystal held between first and second transparent substrates and also including a plurality of display areas;
an absorption polarizer which transmits light vibrating in a first direction and absorbs light vibrating in a direction crossing the first direction, and which is disposed on a side of the first transparent substrate side with respect to the liquid crystal panel; and
a reflection polarizer which transmits light vibrating in a second direction and reflects light vibrating in a direction crossing the second direction, and which is disposed on a side of the second transparent substrate with respect to the liquid crystal panel;
wherein the reflection polarizer is held to the liquid crystal panel via an adhesive layer which has a uniform refractive index.

32. An electric equipment provided with a liquid crystal display, the electric equipment comprising:
a liquid crystal panel including liquid crystal held between first and second transparent substrates and also including a plurality of display areas for viewing target images from a side of the first transparent substrate;
an absorption polarizer which transmits light vibrating in a first direction and absorbs light vibrating in a direction crossing the first direction, and which is disposed on a front face side of the liquid crystal panel;
a reflection polarizer which transmits light vibrating in a second direction and reflects light vibrating in a direction crossing the second direction, and which is disposed on a back face side of the liquid crystal panel; and
a white reflection layer disposed on a back face side of the reflection polarizer.
